(19) United States
(12) Patent Application Publication
(10) Pub. No.: US 2019/0243959 A1
(43) Pub. Date: Aug. 8, 2019

(54) ELECTRONIC DEVICE AND USER AUTHENTICATION METHOD THEREOF

(71) Applicant: Samsung Electronics Co., Ltd., Suwon-si (KR)

(72) Inventor: Antoniewicz RADOSLAW, Warsaw (PL)

(21) Appl. No.: 16/263,727

(22) Filed: Jan. 31, 2019

(30) Foreign Application Priority Data
Feb. 7, 2018 (KR) 10-2018-0015136

(51) Int. Cl. G06F 21/36; H04L 29/06; G06F 3/01; G06F 3/16

(52) U.S. Cl. CPC G06F 21/36; H04L 63/083; H04L 63/18; G06F 3/04883; G06F 3/016; G06F 3/011; G06F 3/16; H04L 63/12

(57) ABSTRACT

An electronic device is provided. An electronic device includes a first interface formed of a secure channel, a second interface formed of an insecure channel, and a processor. The processor is configured to provide first information to a user through the first interface, to receive second information from the user through the second interface, and to verify whether a user input matches a predetermined password, based on a combination of the first information and the second information. Other embodiments are also possible.

### CROSS-REFERENCE TO RELATED APPLICATION(S)

This application is based on and claims priority under 35 U.S.C. § 119(a) of a Korean patent application number 10-2018-0015136, filed on Feb. 7, 2018, in the Korean Intellectual Property Office, the disclosure of which is incorporated by reference herein in its entirety.

### BACKGROUND

The disclosure relates to an electronic device and a user authentication method thereof.

Today, a great variety of portable electronic devices including a smart phone, a tablet PC, a portable multimedia player (PMP), a personal digital assistant (PDA), a laptop personal computer, and a wearable device such as a wrist watch or a head-mounted display (HMD) have been developed and used.

Such electronic devices have a security function to protect a user's privacy. For example, the electronic device can authenticate the user by verifying that a user input matches a predetermined password.

The user can input a password by using a general input device provided by the electronic device. For example, the user may enter a password through a real keypad formed on the electronic device or a virtual keypad displayed on a touch screen of the electronic device. However, in case of using such an input device, a password may be easily exposed to the outside. For example, when the user enters a password through the real or virtual keypad, the password may be exposed to a certain object (e.g., a neighboring person or camera) around the user.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device and a user authentication method thereof.

Additional aspects will be set forth in part in the description which follows and, in part, will be apparent from the description, or may be learned by practice of the presented embodiments.

According to various embodiments of the disclosure, an electronic device and a user authentication method can provide a high-level security without exposing a password even when the password is inputted through a general input device.

According to various embodiments of the disclosure, an electronic device and a user authentication method can allow a password input using a button without using a keypad, thus permitting blind persons to easily use.

In accordance with an aspect of the disclosure, an electronic device is provided. The electronic device includes a first interface formed of a secure channel, a second interface formed of an insecure channel, and a processor configured to provide first information to a user through the first interface, receive second information from the user through the second interface, and verify whether a user input matches a predetermined password, based on a combination of the first information and the second information.

In accordance with another aspect of the disclosure, a user authentication method of an electronic device is provided. The method includes providing first information to a user through a first interface formed of a secure channel, receiving second information from the user through a second interface formed of an insecure channel, and verifying whether a user input matches a predetermined password, based on a combination of the first information and the second information.

According to various embodiments of the disclosure, an electronic device and a user authentication method can prevent the outflow of a password, thereby improving security and stability.

According to various embodiments of the disclosure, an electronic device and a user authentication method can easily authenticate a user even though a screen related to a password input is not displayed on a display.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a flow diagram illustrating a user authentication method of an electronic device according to an embodiment of the disclosure;

FIGS. 3A, 3B, and 3C are diagrams illustrating an electronic device according to various embodiments of the disclosure;

FIG. 4 is a diagram illustrating a user authentication method according to an embodiment of the disclosure;

FIG. 5 is a diagram illustrating a user authentication method according to an embodiment of the disclosure; and

FIG. 6 is a diagram illustrating a user authentication method according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

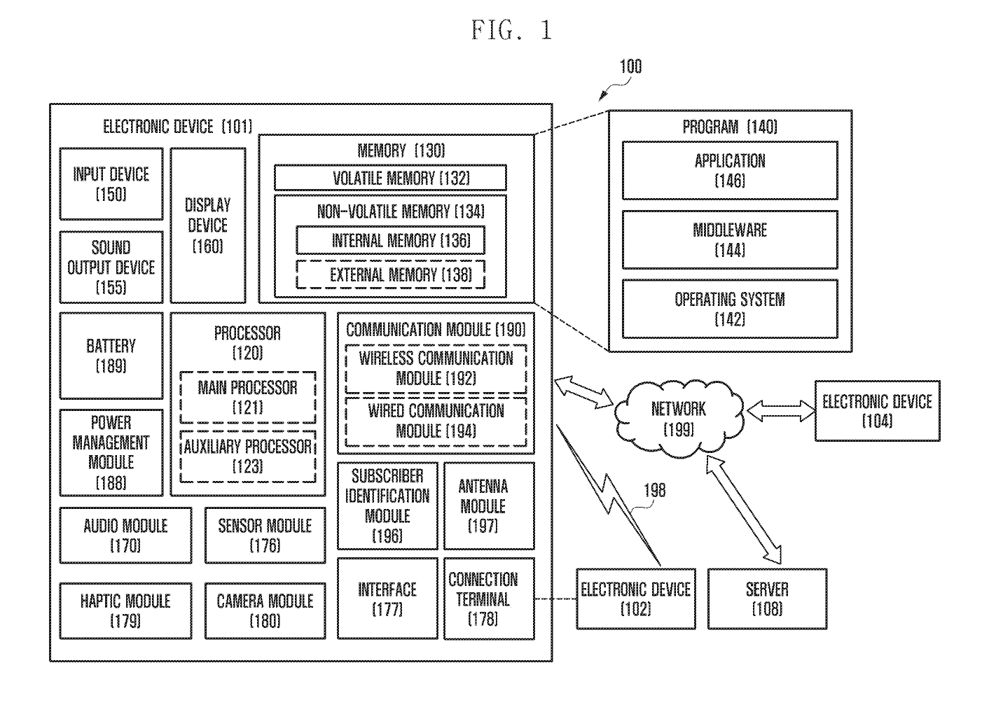

FIG. 1 is a block diagram illustrating an electronic device in a network environment according to an embodiment of the disclosure.

Referring to FIG. 1, an electronic device 101 in a network environment 100 may communicate with a first external electronic device 102 via a first network 198 (e.g., a short-range wireless communication network), or a second external electronic device 104 or a server 108 via a second network 199 (e.g., a long-range wireless communication network). According to an embodiment, the electronic device 101 may communicate with the second external electronic device 104 via the server 108. According to an embodiment, the electronic device 101 may include a processor 120, a memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in a volatile memory 132, process the command or the data stored in the volatile memory 132, and store resulting data in a non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an ISP or a CP) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., the first external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the first external electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the first external electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the first external electronic device 102, the second external electronic device 104, or the server 108) and performing communication via the established communication channel. The communication module 190 may include one or more communication processors that are operable independently from the processor 120 (e.g., the AP) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, Wi-Fi direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., PCB). According to an embodiment, the antenna module 197 may include a plurality of antennas. In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the second external electronic device 104 via the server 108 coupled with the second network 199. Each of the first and second external electronic devices 102 and 104 may be a device of a same type as, or a different type, from the electronic device 101. According to an embodiment, all or some of operations to be executed at the electronic device 101 may be executed at one or more of the first and second external electronic devices 102 and 104 or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

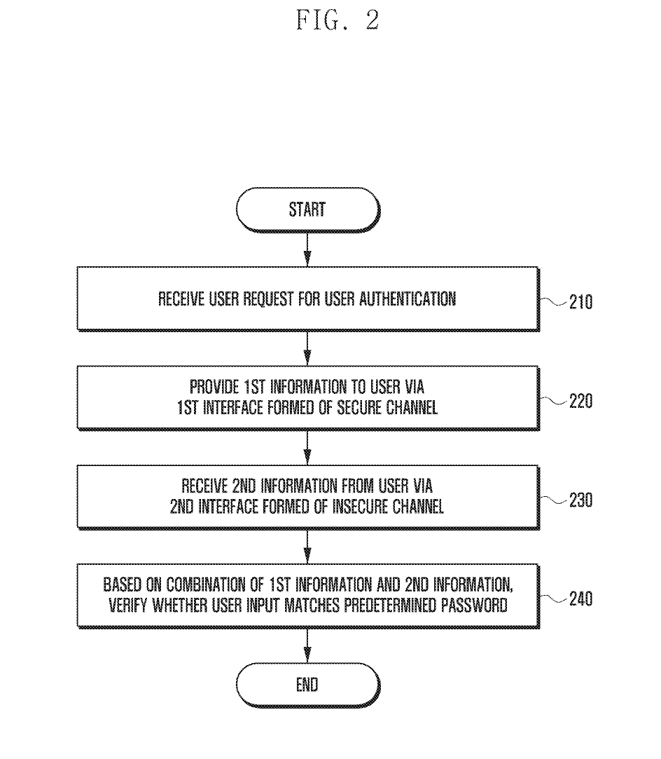

FIG. 2 is a flow diagram illustrating a user authentication method of an electronic device according to an embodiment of the disclosure.

Referring to FIG. 2, at operation 210, the processor 120 of the electronic device 101 may receive a request for user authentication from the user. When a request for unlocking the electronic device 101 is received, or when a request for entering an application or task that requires user authentication, the processor 120 may recognize this request as the request for user authentication. For example, when a predetermined input is received in a locked state, or when an input of pressing a home button or a power button is received, the processor 120 may recognize this input as the request for user authentication.

At operation 220, the processor 120 of the electronic device 101 may provide first information to the user via a first interface formed of a secure channel.

The first interface formed of the secure channel allows providing information only to a particular user. That is, other neighboring objects other than the particular user are incapable of recognizing the information provided via the first interface.

According to various embodiments, the first interface may include a mechanical stimulus (e.g., a vibration or a motion) or electrical stimulus (e.g., a haptic effect) using the haptic module 179, an audio signal through an earset or headset, content implemented in an augmented or virtual reality space, or the like. For example, the electronic device 101 may provide the first information to the user by repeatedly generating the haptic effect. As another example, the electronic device 101 may offer a repetitive signal (e.g., “tick” or “ping”) or a sound (e.g., “seven”) to the user through the earset or headset such that the user can recognize the first information. According to one embodiment, the electronic device 101 may implement an augmented reality or virtual reality and offer certain content related to alphanumeric characters, symbols, icons or pictures such that the user can recognize the first information.

According to various embodiments, the first information may include any numerical information associated with a predetermined password (e.g. PIN). For example, when the predetermined password is formed of a combination of a plurality of numbers, the first information may include any numerical information associated with some or all of the combination of numbers. For example, the electronic device 101 may provide, as the first information, any numerical information associated with some unit numbers in the entire combination of numbers (e.g., “1” in “1234”) through a haptic effect or repetitive signal. As another example, the electronic device 101 may provide, as the first information, the entire combination of numbers at a time by using a specified rule (e.g., Morse code).

According to one embodiment, the electronic device 101 may provide the first information to the user by displaying a predetermined symbol, icon, or picture on the display (e.g., the display device 160) or by rendering it as content in an augmented or virtual reality space. For example, such a symbol, icon, or picture may be predetermined to correspond to numerical information. For example, the symbol “A” may be predetermined to correspond to the number “1” and displayed on the display or rendered as content in the augmented or virtual reality space.

According to one embodiment, the electronic device 101 may provide, as the first information, a plurality of combinations of numbers including a predetermined password. For example, when “1618” is the predetermined password, combinations “5242”, “8261”, “6210”, and “1618” may be provided as the first information.

According to one embodiment, the first information may be provided to the user for a predetermined period of time. For example, the first information providing time may be set in advance, and the first information may be provided during the first information providing time.

At operation 230, the processor 120 of the electronic device 101 may receive second information from the user via a second interface formed of an insecure channel.

The second interface formed of the insecure channel may include various input manners that allow the user to input the second information.

According to various embodiments, the second interface may include certain manners capable of inputting at least binary information. For example, a volume key button, a bezel allowing a motion in at least two directions, a touch screen, a gesture detection sensor, or a virtual keyboard may be used as the second interface.

The user can modify the first information by using the binary information as the second information. According to various embodiments, the first information may include numerical information, and the user may increase or decrease the numerical information by using the binary information. For example, by repeatedly inputting “+1” or “−1”, the user may modify the numerical information included in the first information. When the second information is not inputted, the electronic device 101 may recognize the second information as “0”.

According to one embodiment, when the plurality of combinations of numbers including the predetermined password are provided as the first information, the second information may include a request for selecting one of the plurality of combinations of numbers.

According to one embodiment, the second information may be received from the user for a predetermined period of time. For example, the second information receiving time may be set in advance, and the second information may be provided during the second information receiving time.

At operation 240, the processor 120 of the electronic device 101 may verify whether a user input matches the predetermine password, based on a combination of the first information and the second information.

According to various embodiments, when the second information is a modification of the first information, the electronic device 101 may use the second information verify whether the modified first information matches the predetermined password, and thereby authenticate the user. For example, when the predetermined password is “7” and when the first information includes “4”, the electronic device 101 may authenticate the user by verifying that the second information includes “+3”. In this example, the user may enter “+3” by repeating an input of “+1” three times. In another example, when the predetermined PIN is “2” and when the first information includes “6”, the electronic device 101 may authenticate the user by verifying that the second information includes “−4”. In this example, the user may enter “−4” by repeating an input of “−1” four times.

According to various embodiments, when the plurality of combinations of numbers including the predetermined password are provided as the first information, the electronic device 101 may authenticate the user by verifying that the predetermined password is selected. For example, when the predetermined password is “1618” and when the electronic device 101 provides “5242”, “8261”, “6210”, and “1618” as the first information, the electronic device 101 may authenticate the user by verifying that the user selects “1618”.

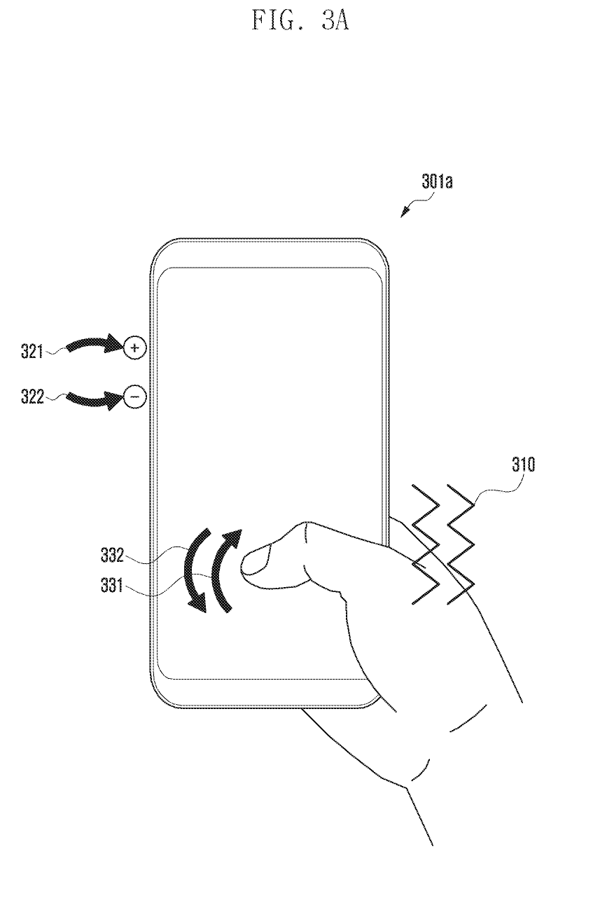

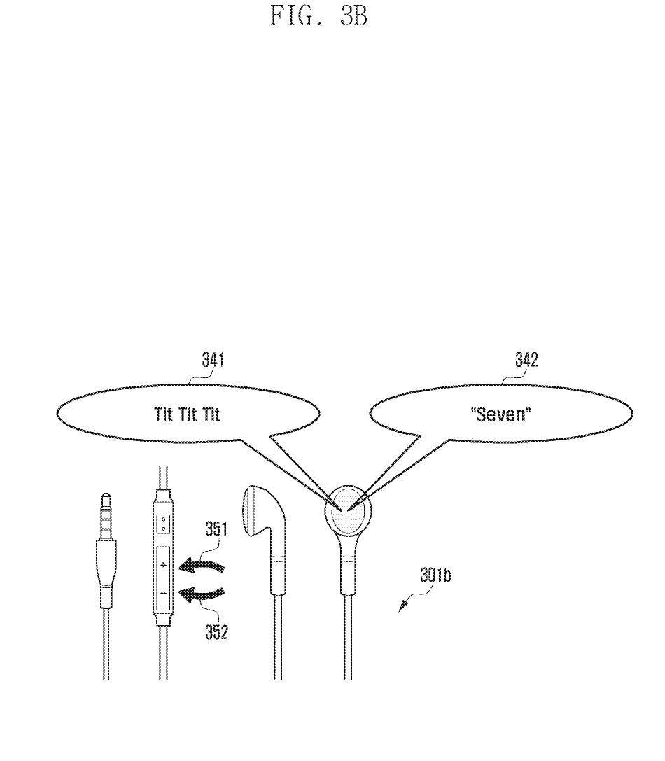

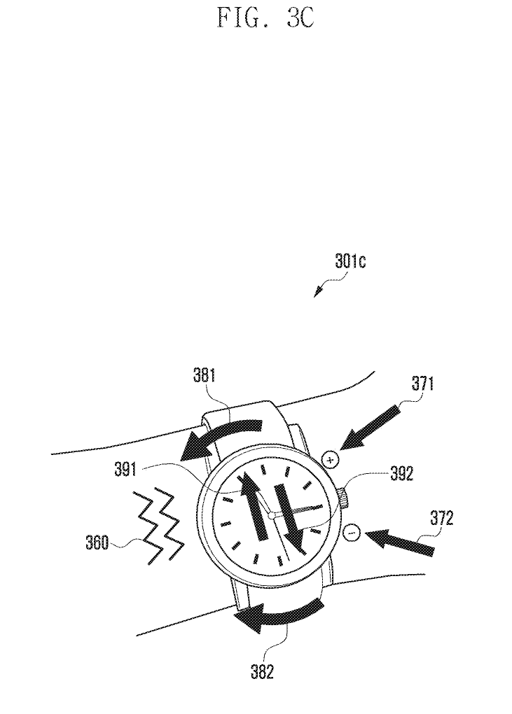

FIGS. 3A, 3B, and 3C are diagrams illustrating an electronic device according to various embodiments of the disclosure.

Referring to FIG. 3A, an electronic device 301a which is a portable terminal (e.g., smart phone). According to various embodiments, the electronic device 301a may provide the first information to the user through a haptic effect 310. For example, the electronic device 301a may repeatedly generate the haptic effect 310 and thereby provide the first information to the user including numerical information. Then, the user may input the second information through volume key buttons (e.g., a volume up button 321 and a volume down button 322). For example, the volume up button 321 and the volume down button 322 may be set to correspond to “+1” and “−1”, respectively.

According to one embodiment, the user may input the second information through the touch screen. For example, a touch input 331 corresponding to “+1” and a touch input 332 corresponding to “−1” may be predefined and used as an input manner for the second information. For example, the second information may be inputted through various manners such as an up/down drag input, a left/right drag input, a single/multi touch input, or an input using a virtual keypad.

Referring to FIG. 3B, an electronic device 301b which is an earset. According to various embodiments, the electronic device 301b may provide the first information to the user through an audio signal. For example, the electronic device 301b may provide a repetitive signal 341 or a sound 342 to allow the user to recognize the first information. Then, the user may input the second information through volume key buttons (e.g., a volume up button 351 and a volume down button 352). For example, the volume up button 351 and the volume down button 352 may be set to correspond to “+1” and “−1”, respectively.

Referring to FIG. 3C, an electronic device 301c which is a wearable device. According to various embodiments, the electronic device 301c may provide the first information to the user through a haptic effect 360. For example, the electronic device 301c may repeatedly generate the haptic effect 360 to provide the first information including numerical information to the user. Then, the user may input the second information through volume key buttons (e.g., a volume up button 371 and a volume down button 372). For example, the volume up button 371 and the volume down button 372 may be set to correspond to “+1” and “−1”, respectively. According to one embodiment, the user may input the second information through a bidirectional motion of the bezel of the electronic device 301c (e.g., a left movement 381 and a right movement 382). In another embodiment, the user may input the second information through the touch screen of the electronic device 301c. For example, a touch input 391 corresponding to “+1” and a touch input 392 corresponding to “−1” may be predetermined and used as an input manner for the second information.

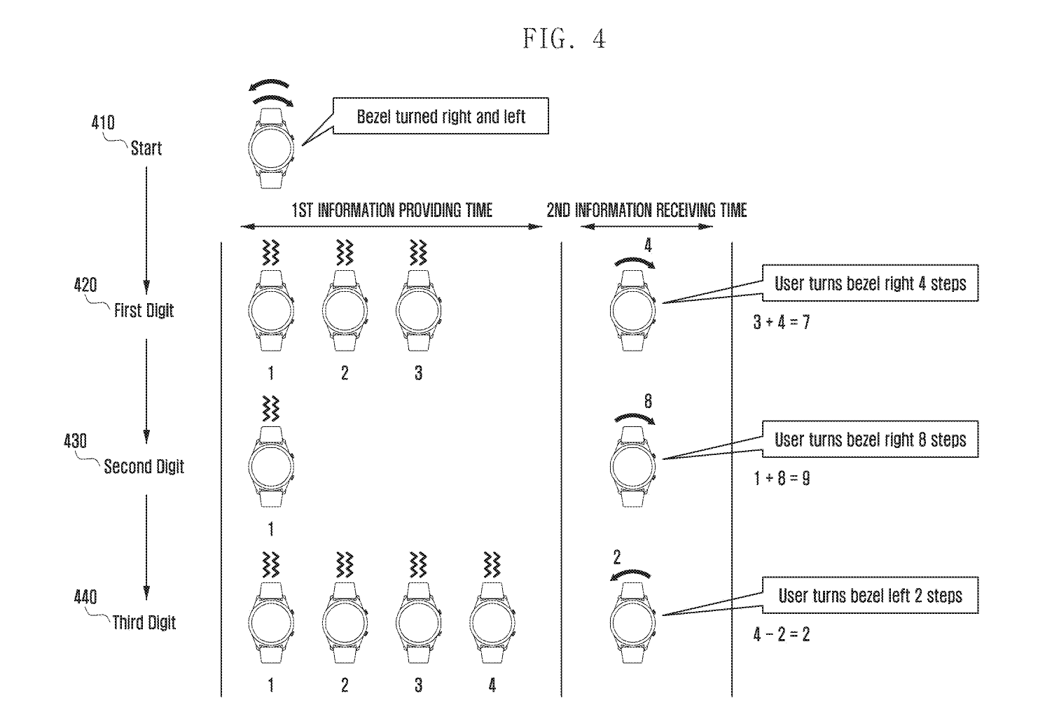

FIG. 4 is a diagram illustrating a user authentication method according to an embodiment of the disclosure.

Referring to FIG. 4, at operation 410 the electronic device 101 may receive a request for user authentication from the user. For example, the electronic device 101 may receive a user input of turning the bezel of the electronic device 101 in the left and right directions and recognize the received input as the request for the user authentication.

At operation 420, the electronic device 101 may provide the first information to the user through the first interface formed of the secure channel. For example, the electronic device 101 may repeatedly generate the haptic effect three times to provide the first information “3”. Then, the user may recognize the first information and input the second information through the second interface. For example, the user may input the second information “4” by turning the bezel of the electronic device 101 four times in the right direction. Therefore, a resultant user input becomes “7”.

Operations 430 and 440 are similar in process to the above operation 420. That is, the electronic device 101 provides the first information to the user through the first interface formed of the secure channel, and then the user recognizes the first information and uses the second interface to input the second information. For example, at operation 430, the electronic device 101 may generate the haptic effect once to provide the first information “1”, and the user may turn the bezel of the electronic device 101 eight times in the right direction to input the second information “8”. Therefore, a resultant user input becomes “9”. At operation 440, the electronic device 101 may repeatedly generate the haptic effect four times to provide the first information “4”, and the user may turn the bezel of the electronic device 101 twice in the left direction to input the second information “−2”. Therefore, a resultant user input becomes “2”. When the second information is not received, the electronic device 101 recognizes the second information as “0”.

As a result, the electronic device 101 receives a user input “792” and then authenticates the user by verifying that the user input “792” matches the predetermined password.

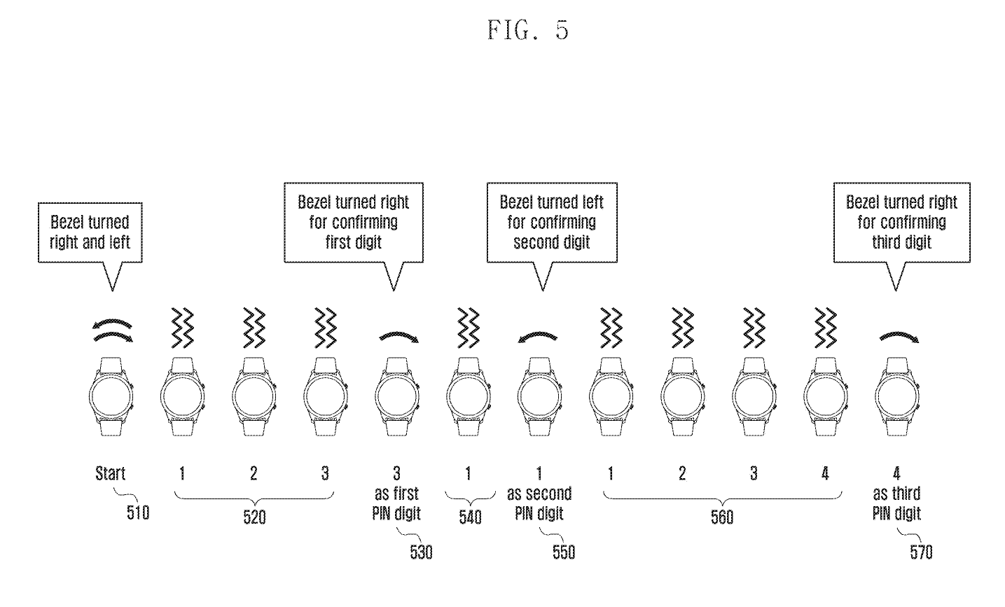

FIG. 5 is a diagram illustrating a user authentication method according to an embodiment of the disclosure.

Referring to FIG. 5, at operation 510 the electronic device 101 may receive a request for user authentication from the user. For example, the electronic device 101 may receive a user input of turning the bezel of the electronic device 101 in the left and right directions and recognize the received input as the request for the user authentication.

At operation 520, the electronic device 101 may provide the first information to the user through the first interface formed of the secure channel. For example, the electronic device 101 may generate and provide periodically repeated haptic effects.

At operation 530, the user may count the repeated haptic effects and, when a desired count is reached, input the second information. For example, when the haptic effects occur three times, the user may turn the bezel in the right direction. At this time, the electronic device 101 recognizes the second information as “3”.

Similarly, the electronic device 101 may provide periodically repeated haptic effects at operation 540, and the user may input the second information at operation 550 when a desired count is reached. For example, when the haptic effect occurs once, the user may turn the bezel in the left direction to input the second information “1”. Although FIG. 5 shows both a rightward turn and a leftward turn, this embodiment is not limited to the turning direction. Alternatively, the second information may be inputted by turning the bezel in the same direction.

In addition, at operation 560, the electronic device 101 may provide periodically repeated haptic effects. When the haptic effects occur four times, the user may turn the bezel in the right direction to input the second information “4” at operation 570.

As a result, the electronic device 101 receives a user input “314” and then authenticates the user by verifying that the user input “314” matches the predetermined password.

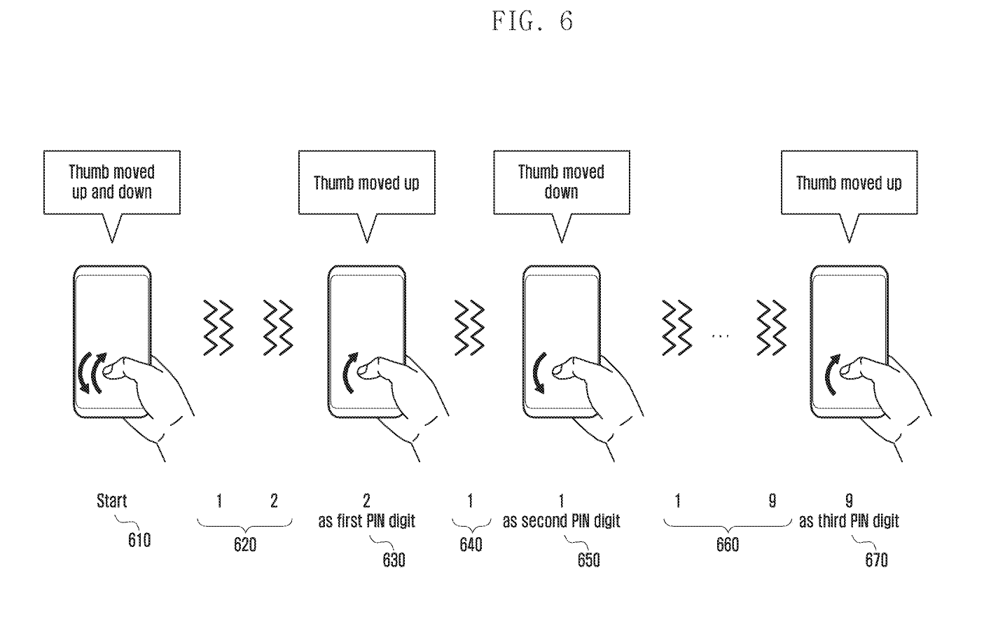

FIG. 6 is a diagram illustrating a user authentication method according to an embodiment of the disclosure.

Referring to FIG. 6, at operation 610 the electronic device 101 may receive a request for user authentication from the user. For example, the electronic device 101 may receive a user input of drag on the touch screen of the electronic device 101 in the up and down direction and recognize the received input as the request for the user authentication.

At operation 620, the electronic device 101 may provide the first information to the user through the first interface formed of the secure channel. For example, the electronic device 101 may generate and provide periodically repeated haptic effects.

At operation 630, the user may count the repeated haptic effects and, when a desired count is reached, input the second information. For example, when the haptic effects occur twice, the user may input an upward drag on the touch screen. At this time, the electronic device 101 recognizes the second information as “2”.

Similarly, the electronic device 101 may provide periodically repeated haptic effects at operation 640, and the user may input the second information at operation 650 when a desired count is reached. For example, when the haptic effect occurs once, the user may input a downward drag on the touch screen to input the second information “1”.

In addition, at operation 660, the electronic device 101 may provide periodically repeated haptic effects. When the haptic effects occur nine times, the user may input an upward drag on the touch screen to input the second information “9” at operation 670.

As a result, the electronic device 101 receives a user input “219” and then authenticates the user by verifying that the user input “219” matches the predetermined password.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a first interface formed of a secure channel;
a second interface formed of an insecure channel; and
a processor configured to:
provide first information to a user through the first interface,
receive second information from the user through the second interface, and
verify whether a user input matches a predetermined password, based on a combination of the first information and the second information.

2. The electronic device of claim 1, wherein the first interface comprises at least one of a mechanical stimulus or an electrical stimulus using a haptic module, an audio signal through an earset or headset, or content implemented in an augmented or virtual reality space.

3. The electronic device of claim 1, wherein the first information comprises numerical information associated with the predetermined password.

4. The electronic device of claim 3,
wherein the numerical information is formed of a combination of a plurality of numbers, and
wherein the processor is further configured to provide the first information in a form of some unit numbers in the combination of the plurality of numbers.

5. The electronic device of claim 1, wherein the processor is further configured to provide the first information in a form of a periodically repeated signal.

6. The electronic device of claim 2, wherein the content comprises a symbol, an icon, or a picture.

7. The electronic device of claim 6, wherein the symbol, the icon, or the picture is predetermined to correspond to numerical information.

8. The electronic device of claim 1, wherein the second interface comprises at least one of a volume key button, a bezel allowing a motion in at least two directions, a touch screen, a gesture detection sensor, or a virtual keyboard.

9. The electronic device of claim 1, wherein the second information comprises binary information.

10. The electronic device of claim 9, wherein the processor is further configured to modify the first information by using the binary information to thereby authenticate the user.

11. A user authentication method of an electronic device, the method comprising:
providing first information to a user through a first interface formed of a secure channel;
receiving second information from the user through a second interface formed of an insecure channel; and
verifying whether a user input matches a predetermined password, based on a combination of the first information and the second information.

12. The method of claim 11, wherein the first interface comprises at least one of a mechanical stimulus or an electrical stimulus using a haptic module, an audio signal through an earset or headset, or content implemented in an augmented or virtual reality space.

13. The method of claim 11, wherein the first information comprises numerical information associated with the predetermined password.

14. The method of claim 13,
wherein the numerical information is formed of a combination of a plurality of numbers, and
wherein the first information is provided in a form of some unit numbers in the combination of the plurality of numbers.

15. The method of claim 11, wherein the first information is provided in a form of a periodically repeated signal.

16. The method of claim 12, wherein the content comprises a symbol, an icon, or a picture.

17. The method of claim 16, wherein the symbol, the icon, or the picture is predetermined to correspond to numerical information.

18. The method of claim 11, wherein the second interface comprises at least one of a volume key button, a bezel allowing a motion in at least two directions, a touch screen, a gesture detection sensor, or a virtual keyboard.

19. The method of claim 11, wherein the second information comprises binary information.

20. The method of claim 19, wherein the verifying of whether the user input matches the predetermined password comprises modifying the first information by using the binary information to thereby authenticate the user.
